(19) United States
(12) Patent Application Publication
(10) Pub. No.: US 2017/0354157 A1
(43) Pub. Date: Dec. 14, 2017

(54) Method to Improve Sliceability of Baked Goods

(71) Applicant: NOVOZYMES A/S, Bagsvaerd (DK)

(72) Inventors: Guillermo BELLIDO, Dittingen (CH); Sven SCHOENENBERG, Neumattweg (CH)

(73) Assignee: Novozymes A/S, Bagsvaerd (DK)

(21) Appl. No.: 15/542,122

(22) PCT Filed: Jan. 15, 2016
(86) PCT No.: PCT/EP2016/050788

§ 371 Date: Jul. 7, 2017

(30) Foreign Application Priority Data
Jan. 16, 2015 (EP) 15151444.5

(51) Int. Cl. A21D 8/04; A21D 13/40; A21D 10/00

(52) U.S. Cl. CPC A21D 8/042; C12Y 204/01018; C12Y 204/01019; A21D 10/002; A21D 13/40

(57) ABSTRACT

The invention discloses a method of improving sliceability of a baked product prepared from dough comprising: —incorporating into the dough a glycosyltransferase (EC 2.4.1.18) and/or a cyclomaltodextrin glucanotransferase; —baking the dough into a baked product; and —slicing the baked product during the cooling period when the baked product has a core temperature of 30-55° C.

### REFERENCE TO A SEQUENCE LISTING

This application contains a Sequence Listing in computer readable form, which is incorporated herein by reference.

### BACKGROUND OF THE INVENTION

### Field of the Invention

The present invention relates to a method of improving the sliceability of baked goods, e.g., bread, by using a glycosyltransferase, a cyclomaltodextrin glucanotransferase, or a mixture of a glycosyltransferase and a cyclomaltodextrin glucanotransferase.

### Description of the Related Art

In the manufacturing of baked goods, particularly in high speed bread production or in industrialized processes using automated or semi-automated equipment, slicing is an important unit process operation that follows baking and precedes packing.

Bread, e.g., toast and sandwich bread, is typically cooled before slicing and packing, otherwise, the crumb will have poor sliceability properties. On removal from the oven, bread has a temperature of around 150-180° C. at its crust and 95-100° C. in its core.

During the cooling process, the baked bread loses moisture and the gelatinized starch sets into the final crumb structure. Setting of the crumb leads to the firming of the bread which in turn facilitates slicing.

Depending on the size and shape of the loaf, it may take up to 2-3 hours for the bread to completely cool and at this point the temperature gradient between the crust and the crumb becomes zero. However, in high speed bread production slicing of the bread is accomplished before bread is completely cooled. This is critical, as unwarranted prolongation of the cooling process causes, among others, undue extension of the manufacturing process, excessive loss of moisture, and bigger risk of microbial contamination.

In the manufacturing of baked goods, particularly in high speed bread production, the end of the cooling cycle is reached when the core temperature of bread is reduced to a desirable temperature range, most commonly 30-38° C. If bread is sliced at a higher temperature range, the crumb is typically gummy and sticks to the cutting blades, causing quality issues or production issues, including production downtime, such as to clean the blades of the slicer to avoid damaging of bread slices.

In the manufacturing of baked goods, especially in high speed bread production, cooling of bread is accelerated by using various types of cooling systems, e.g., convection cooling, conditioned air cooling, and vacuum cooling, each of which offers different benefits in terms of degree of control of moisture loss in the cooling loaf, speed of the cooling process, energy consumption and capital expense among other considerations. There are situations in which slicing of bread at temperatures higher than 30-38° C. is desirable, e.g., slicing of bread at a temperature in the range of from 38° C. to 55° C.

Some of the advantages of slicing bread at higher temperatures include higher processing throughputs, shorter overall processing times (due to shorter cooling times), energy savings due to the need to remove less heat from the cooling bread, and improved process robustness as slicing can be accomplished over a wider temperature range. However, slicing bread at the desirable temperature range of 30-38° C. or a customarily lower temperature range may still cause sliceability issues. Such issues may arise due to the need to change bread formulation (e.g., new flour batch, flour from a new crop year, addition/removal of bread additives, addition/removal of processing aids, and addition/removal of new functional ingredients), bread manufacturing practices, and introduction of new baking equipment technology or other changes in bread production.

Bread rejects due to slicing defects can include such defects as the permanent deformation of single or multiple slices, deformation of the whole loaf, sticking together of two or more contiguous slices, loosening or peeling off of crumb surface, excessive removal of crumbs from crumb surface, any undue deterioration of crumb grain texture (e.g., crumb holes), or more than one of the aforementioned defects combined.

Recently, the product Soft′r Intens Sliceability™ (produced by Puratos) has been commercially available.

There is still a need in the art for improving the slicing properties of toast bread, especially soft toast bread, when sliced at high core temperatures.

### SUMMARY OF THE INVENTION

The inventors have found that the addition to the dough of a glycosyltransferase and/or a cyclomaltodextrin glucanotransferase has a surprising effect on the sliceability of the baked product when slicing the baked product at a high core temperature.

Accordingly, the invention provides a method of improving sliceability of a baked product prepared from dough comprising incorporating into the dough a glycosyltransferase and/or a cyclomaltodextrin glucanotransferase; and slicing the baked product at a core temperature of the baked product of 30-55° C.

In particular, the invention provides a method of improving sliceability of a baked product prepared from dough comprising:
incorporating into the dough a glycosyltransferase (EC 2.4.1.18) and/or a cyclomaltodextrin glucanotransferase;
   baking the dough into a baked product; and
   slicing the baked product during the cooling period when the baked product has a core temperature of 30-55° C.

In one embodiment, the glycosyltransferase has at least 80% sequence identity to the polypeptide of SEQ ID NO: 1.

In one embodiment, the cyclomaltodextrin glucanotransferase has at least 80% sequence identity to the polypeptide of SEQ ID NO: 2.

In one embodiment, a glycosyltransferase and a cyclomaltodextrin glucanotransferase are incorporated into the dough.

In one embodiment, additionally an enzyme selected from the group consisting of amylase, xylanase, glucanase, galactanase, mannanase, aminopeptidase, alpha-amylase, beta-amylase, anti-staling alpha-amylase, carboxypeptidase, catalase, chitinase, cutinase, deoxyribonuclease, esterase, alpha-galactosidase, beta-galactosidase, glucoamylase, alpha-glucosidase, beta-glucosidase, haloperoxidase, invertase, laccase, lipase, phospholipase, mannosidase, oxidase, pectinolytic enzymes, peptidoglutaminase, protease, peroxidase, phytase, and polyphenoloxidase is added to the dough.

In one embodiment, the glycosyltransferase and/or the cyclomaltodextrin glucanotransferase is applied in an amount of 0.01-100 mg enzyme protein per kg flour.

In one embodiment, the baked product is sliced at a core temperature of the baked product of 38-55° C.

In one embodiment, the sliceability of the baked product is improved compared to a baked product prepared from dough wherein no glycosyltransferase and/or a cyclomaltodextrin glucanotransferase is added to the dough.

In one embodiment, the crumb structure of the baked product is improved compared to a baked product prepared from dough wherein no glycosyltransferase and/or a cyclomaltodextrin glucanotransferase is added to the dough.

In one embodiment, the baked product is a bread; preferably a toast bread; in particular a lidded toast bread.

In one embodiment, the invention discloses a baking composition comprising a glycosyltransferase and/or a cyclomaltodextrin glucanotransferase for use in improving sliceability in a baked product.

In one embodiment, the baking composition further comprises an enzyme selected from the group consisting of amylase, glucanase, galactanase, mannanase, aminopeptidase, alpha-amylase, beta-amylase, anti-staling alpha-amylase, carboxypeptidase, catalase, chitinase, cutinase, cyclodextrin glycosyltransferase, deoxyribonuclease, esterase, alpha-galactosidase, beta-galactosidase, glucoamylase, alpha-glucosidase, beta-glucosidase, haloperoxidase, invertase, laccase, mannosidase, oxidase, pectinolytic enzymes, peptidoglutaminase, protease, peroxidase, phytase, and polyphenoloxidase.

In one embodiment, the invention discloses a pre-mix comprising a baking composition comprising a glycosyltransferase and/or a cyclomaltodextrin glucanotransferase, flour, and one or more dough or bread additives for use in improving sliceability in a baked product.

In one embodiment, the invention discloses use of a baking composition comprising a glycosyltransferase and/or a cyclomaltodextrin glucanotransferase for improving sliceability of a baked product, wherein the baked product has a core temperature of 30-55° C.

### BRIEF DESCRIPTION OF THE FIGURES

FIG. 1: Sliceability with a mixture of glycosyltransferase (SEQ ID NO:1) and cyclomaltodextrin glucanotransferase (SEQ ID NO:2).

FIG. 2: Sliceability with glycosyltransferase (SEQ ID NO:1).

FIG. 3: Sliceability with cyclomaltodextrin glucanotransferase (SEQ ID NO:2).

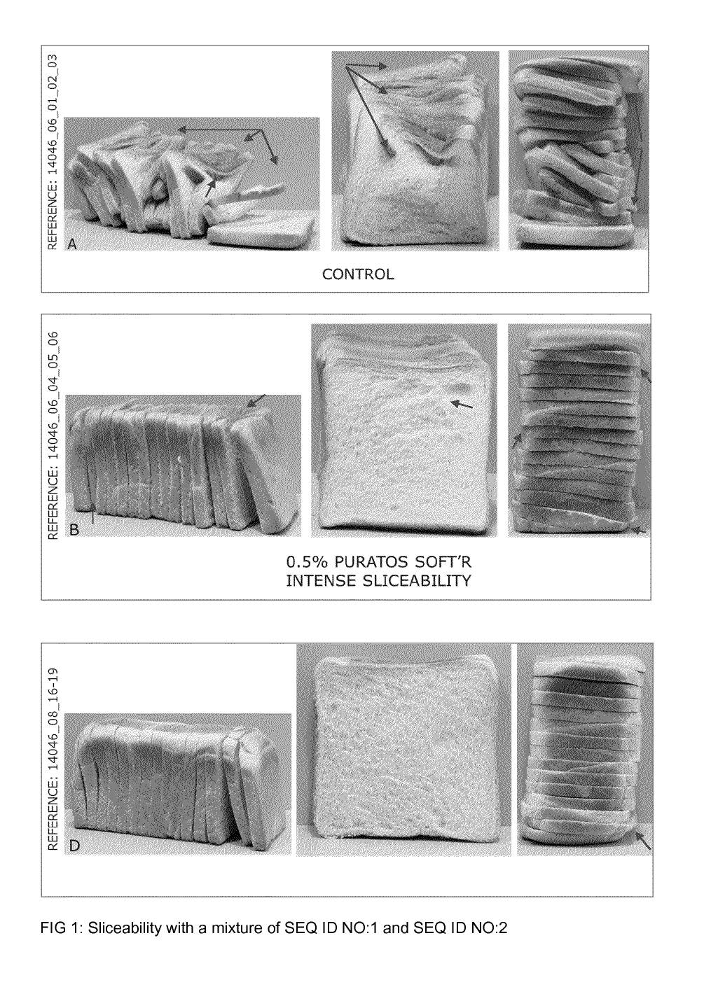

FIG. 1-3: The breads were made according to Example 2-4 and sliced at a core temperature of 48-50° C. and a slice thickness of 12.5 mm.

### DEFINITIONS

Coding sequence: The term “coding sequence” means a polynucleotide, which directly specifies the amino acid sequence of a polypeptide. The boundaries of the coding sequence are generally determined by an open reading frame, which begins with a start codon such as ATG, GTG, or TTG and ends with a stop codon such as TAA, TAG, or TGA. The coding sequence may be a genomic DNA, cDNA, synthetic DNA, or a combination thereof.

Fragment: The term “fragment” means a polypeptide having one or more (e.g. several) amino acids absent from the amino and/or carboxyl terminus of a mature polypeptide or domain.

Host cell: The term “host cell” means any cell type that is susceptible to transformation, transfection, transduction, or the like with a nucleic acid construct or expression vector comprising a polynucleotide of the present invention. The term “host cell” encompasses any progeny of a parent cell that is not identical to the parent cell due to mutations that occur during replication.

Isolated: The term “isolated” means a substance in a form or environment that does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g. multiple copies of a gene encoding the substance; use of a stronger promoter than the promoter naturally associated with the gene encoding the substance). An isolated substance may be present in a fermentation broth sample.

Mature polypeptide: The term “mature polypeptide” means a polypeptide in its final form following translation and any post-translational modifications, such as N-terminal processing, C-terminal truncation, glycosylation, phosphorylation, etc.

Mature polypeptide coding sequence: The term “mature polypeptide coding sequence” means a polynucleotide that encodes a mature a glycosyltransferase or a cyclomaltodextrin glucanotransferase polypeptide.

Sequence identity: The relatedness between two amino acid sequences or between two nucleotide sequences is described by the parameter “sequence identity”. For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment).

Improved property: When incorporated into a dough in effective amounts, the glycosyltransferase and/or a cyclomaltodextrin glucanotransferase, may improve one or more properties of the baked product obtained therefrom relative to a baked product in which the glycosyltransferase and/or a cyclomaltodextrin glucanotransferase are not incorporated.

The term “improved property” is defined herein as any property of a baked product, which is improved by the action of a glycosyltransferase and/or a cyclomaltodextrin glucanotransferase relative to a baked product in which a glycosyltransferase and/or a cyclomaltodextrin glucanotransferase according to the invention is not incorporated.

The improved property may include, but is not limited to, improved sliceability of the baked product, improved flavor of the baked product, improved crumb structure of the baked product, improved crumb surface of the baked product, and/or improved texture of the baked product.

The improved property may be determined by comparison of a baked product prepared with and without addition of a glycosyltransferase and/or a cyclomaltodextrin glucanotransferase in accordance with the methods of the present invention which are described below.

Improved flavor of the baked product: Organoleptic qualities may be evaluated using procedures well established in the baking industry, and may include, for example, the use of a panel of trained taste-testers.

Improved crumb structure of the baked product: The term “improved crumb structure of the baked product” is defined herein as the property of a baked product with finer cells and/or thinner cell walls in the crumb and/or more uniform/homogenous distribution of cells in the crumb and is usually evaluated visually by the baker or by digital image analysis as known in the art (e.g. C-cell, Calibre Control International Ltd, Appleton, Warrington, UK).

Improved sliceability: While slicing is a common unit process operation in the manufacturing of many baked goods, no standard method exists to measure bread sliceability. According to the present invention, improved sliceability is defined as the degree to which baked bread having a given core temperature can be sliced into slices with fewer defects—compared to a control—using a slicing machine or a hand knife and a standardized protocol.

### DETAILED DESCRIPTION OF THE INVENTION

The invention provides a method for preparing a baked product prepared from the dough which method comprises incorporating into the dough a glycosyltransferase and/or a cyclomaltodextrin glucanotransferase.

The invention also provides baking compositions, and pre-mix comprising a glycosyltransferase and/or a cyclomaltodextrin glucanotransferase.

### Glycosyltransferases

Glycosyltransferases are enzymes (EC 2.4.1.18) that establish natural glycosidic linkages, including the biosynthesis of disaccharides, oligosaccharides and polysaccharides. They catalyse the transfer of monosaccharide moieties from activated nucleotide sugar (also known as the “glycosyl donor”) to a glycosyl acceptor molecule, usually an alcohol.

Glycosyltransferase activity may be determined as known in the art, e.g., by using a modified version of the procedure described by Takata et al., Applied and Environmental Microbiology (1994), p. 3097 (assay A). Fifty microliter enzyme solution is diluted in double-deionized water and mixed with 50 microliter substrate solution and incubated for 30 min at 50° C. The substrate solution is 0.075% type III amylose dissolved in 78 mM Tris buffer (e.g., 30 mg amylose dissolved by subsequent addition of 0.8 mL 96% ethanol, 2 mL 2 M NaOH, 4 mL double de-ionized water and 2 mL 2M HCl. Finally 31.2 mL 0.1 M Tris buffer (pH 7.2 at 22° C.)). The reaction is terminated by the addition of 150 microliter of iodine reagent. Iodine reagent is made daily from 0.5 mL of stock solution (0.26 g of I₂ and 2.6 g of KI in 10 mL of double de-ionized water) mixed with 0.5 mL of 1 M HCl, and diluted to a total volume of 130 mL. The mixture is incubated for 5 minutes at 50° C. to form the color. Activity is measured as difference in absorbance at 660 nm between a tested sample and a control in which cell extract (enzyme solution) is replaced by double de-ionized water. One unit of branching enzyme activity is defined as the amount of enzyme that can decrease the absorbance at 660 nm compared to the control by 0.7% per minute at 50° C. under the conditions described above.

Useful glycosyltransferases according to the present invention are described in US 2007/0015679. In particular, a glycosyltransferase to be applied in the methods and compositions of the present invention, relates to isolated polypeptides comprising amino acid sequences having a degree of sequence identity to the polypeptide of SEQ ID NO: 1 of preferably at least 80%, e.g., at least 81%, e.g., at least 82%, e.g., at least 83%, e.g., at least 84%, e.g., at least 85%, e.g., at least 86%, e.g., at least 87%, e.g., at least 88%, e.g., at least 89%, e.g., at least 90%, e.g., at least 91%, e.g., at least 92%, e.g., at least 93%, e.g., at least 94%, e.g., at least 95%, e.g., at least 96%, e.g., at least 97%, e.g., at least 98%, e.g., at least 99%, e.g., 100%, which have glycosyltransferase activity.

In a preferred aspect, the glycosyltransferase according to the invention comprise amino acid sequences that differ by 1-10 amino acids, e.g., by up to ten amino acids, e.g., by up to nine amino acids, e.g., by up to eight amino acids, preferably by up to seven amino acids, e.g., by up to six amino acids, e.g., by up to five amino acids, preferably by up to four amino acids, e.g., by up to three amino acids, e.g., by up to two amino acids, and e.g., by one amino acid from the polypeptide of SEQ ID NO: 1.

A glycosyltransferase preferably comprises the amino acid sequence of SEQ ID NO: 1 or an allelic variant thereof; or a fragment thereof having glycosyltransferase activity.

In one embodiment, the glycosyltransferase comprises the amino acid sequence of SEQ ID NO: 1. In one embodiment, the glycosyltransferase consists of the amino acid sequence of SEQ ID NO: 1.

The amino acid sequence of SEQ ID NO: 1; or a fragment thereof, may be used to design nucleic acid probes to identify and clone DNA encoding polypeptides having glycosyltransferase activity from strains of different genera or species according to methods well known in the art. In particular, such probes can be used for hybridization with the genomic or cDNA of the genus or species of interest, following standard Southern blotting procedures, in order to identify and isolate the corresponding gene therein. Such probes can be considerably shorter than the entire sequence, but should be at least 14, preferably at least 25, more preferably at least 35, and most preferably at least 70 nucleotides in length. Preferably, the nucleic acid probe is at least 100 nucleotides in length. For example, the nucleic acid probe may be at least 200 nucleotides, preferably at least 300 nucleotides, more preferably at least 400 nucleotides, or most preferably at least 500 nucleotides in length. Even longer probes may be used, e.g., nucleic acid probes that are preferably at least 600 nucleotides, more preferably at least 700 nucleotides, even more preferably at least 800 nucleotides, or most preferably at least 900 nucleotides in length. Both DNA and RNA probes can be used. The probes are typically labeled for detecting the corresponding gene (for example, with ³²P, ³H, ³⁵S, biotin, or avidin). Such probes are encompassed by the present invention.

A genomic DNA or cDNA library prepared from such other strains may, therefore, be screened for DNA that hybridizes with the probes described above and encodes a glycosyltransferase. Genomic or other DNA from such other strains may be separated by agarose or polyacrylamide gel electrophoresis, or other separation techniques. DNA from the libraries or the separated DNA may be transferred to and immobilized on nitrocellulose or other suitable carrier material.

For purposes of the present invention, hybridization indicates that the nucleotide sequence hybridizes to a labeled nucleic acid probe corresponding to the polypeptide coding sequence of SEQ ID NO: 1.

In another aspect, the glycosyltransferase comprises a substitution, deletion, and/or insertion of one or more (or several) amino acids of the polypeptide of SEQ ID NO: 1, or a homologous sequence thereof. Preferably, amino acid changes are of a minor nature, that is conservative amino acid substitutions or insertions that do not significantly affect the folding and/or activity of the protein; small deletions, typically of one to about 30 amino acids; small amino- or carboxyl-terminal extensions, such as an amino-terminal methionine residue; a small linker peptide of up to about 20-25 residues; or a small extension that facilitates purification by changing net charge or another function, such as a poly-histidine tract, an antigenic epitope or a binding domain.

Examples of conservative substitutions are within the group of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. The most commonly occurring exchanges are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/Ile, Leu/Val, Ala/Glu, and Asp/Gly.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in a parent polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for boosting effect on starch saccharification to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labeling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identities of essential amino acids can also be inferred from analysis of identities with polypeptides that are related to the parent polypeptide.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochemistry 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

The total number of amino acid substitutions, deletions and/or insertions of the mature polypeptide of SEQ ID NO: 1 may not be more than 10, e.g., 1, 2, 3, 4, 5, 6, 7, 8 or 9.

A genomic DNA or cDNA library prepared from such other strains may, therefore, be screened for DNA that hybridizes with the probes described above and encodes a glycosyltransferase. Genomic or other DNA from such other strains may be separated by agarose or polyacrylamide gel electrophoresis, or other separation techniques. DNA from the libraries or the separated DNA may be transferred to and immobilized on nitrocellulose or other suitable carrier material.

For purposes of the present invention, hybridization indicates that the nucleotide sequence hybridizes to a labeled nucleic acid probe corresponding to the polypeptide coding sequence of SEQ ID NO: 1.

In another aspect, the glycosyltransferase comprises a substitution, deletion, and/or insertion of one or more (or several) amino acids of the polypeptide of SEQ ID NO: 1, or a homologous sequence thereof. Preferably, amino acid changes are of a minor nature, that is conservative amino acid substitutions or insertions that do not significantly affect the folding and/or activity of the protein; small deletions, typically of one to about 30 amino acids; small amino- or carboxyl-terminal extensions, such as an amino-terminal methionine residue; a small linker peptide of up to about 20-25 residues; or a small extension that facilitates purification by changing net charge or another function, such as a poly-histidine tract, an antigenic epitope or a binding domain.

### Cyclomaltodextrin Glucanotransferases

A cyclomaltodextrin glucanotransferase (EC 2.4.1.19) is an enzyme that catalyzes the chemical reaction of cyclizing part of a 1,4-alpha-D-glucan molecule through the formation of a 1,4-alpha-D-glucosidic bond. It belongs to the family of glycosyltransferases.

Cyclomaltodextrin glucanotransferase activity may be measured as known in the art, e.g., by incubating enzyme with 5.92 g/L starch in 85 mM HEPES buffer (pH 6.2) and 0.46 mM Ca²⁺ for 20 min at 50° C. Subsequently, increase in reducing sugar may be determined by appropriate method (e.g. PAHBAH/Bi complexing). One enzyme unit is defined as the amount of enzyme forming 1 micromol of reducing sugar (glucose equivalents) per min at the conditions described above.

Useful cyclomaltodextrin glucanotransferases according to the present invention are described in WO 89/03421. In particular, a cyclomaltodextrin glucanotransferase to be applied in the methods and compositions of the present invention, relates to isolated polypeptides comprising amino acid sequences having a degree of sequence identity to the polypeptide of SEQ ID NO: 2 of preferably at least 80%, e.g., at least 81%, e.g., at least 82%, e.g., at least 83%, e.g., at least 84%, e.g., at least 85%, e.g., at least 86%, e.g., at least 87%, e.g., at least 88%, e.g., at least 89%, e.g., at least 90%, e.g., at least 91%, e.g., at least 92%, e.g., at least 93%, e.g., at least 94%, e.g., at least 95%, e.g., at least 96%, e.g., at least 97%, e.g., at least 98%, e.g., at least 99%, e.g., 100%, which have cyclomaltodextrin glucanotransferase activity.

In a preferred aspect, the cyclomaltodextrin glucanotransferase according to the invention comprise amino acid sequences that differ by 1-10 amino acids, preferably by up to ten amino acids, preferably by up to nine amino acids, preferably by up to eight amino acids, preferably by up to seven amino acids, preferably by up to six amino acids, preferably by up to five amino acids, preferably by up to four amino acids, preferably by up to three amino acids, preferably by up to two amino acids, and preferably by one amino acid from the polypeptide of SEQ ID NO: 2.

A cyclomaltodextrin glucanotransferase preferably comprises the amino acid sequence of SEQ ID NO: 2 or an allelic variant thereof; or a fragment thereof having cyclomaltodextrin glucanotransferase activity.

In one embodiment, the cyclomaltodextrin glucanotransferase comprises the amino acid sequence of SEQ ID NO: 2. In one embodiment, the cyclomaltodextrin glucanotransferase consists of the amino acid sequence of SEQ ID NO: 2.

The amino acid sequence of SEQ ID NO: 2; or a fragment thereof, may be used to design nucleic acid probes to identify and clone DNA encoding polypeptides having cyclomaltodextrin glucanotransferase activity from strains of different genera or species according to methods well known in the art. In particular, such probes can be used for hybridization with the genomic or cDNA of the genus or species of interest, following standard Southern blotting procedures, in order to identify and isolate the corresponding gene therein. Such probes can be considerably shorter than the entire sequence, but should be at least 14, preferably at least 25, more preferably at least 35, and most preferably at least 70 nucleotides in length. Preferably, the nucleic acid probe is at least 100 nucleotides in length. For example, the nucleic acid probe may be at least 200 nucleotides, preferably at least 300 nucleotides, more preferably at least 400 nucleotides, or most preferably at least 500 nucleotides in length. Even longer probes may be used, e.g., nucleic acid probes that are preferably at least 600 nucleotides, more preferably at least 700 nucleotides, even more preferably at least 800 nucleotides, or most preferably at least 900 nucleotides in length. Both DNA and RNA probes can be used. The probes are typically labeled for detecting the corresponding gene (for example, with ³²P, ³H, ³⁵S, biotin, or avidin). Such probes are encompassed by the present invention.

Examples of conservative substitutions are within the group of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. The most commonly occurring exchanges are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/Ile, Leu/Val, Ala/Glu, and Asp/Gly.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in a parent polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for boosting effect on starch saccharification to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labeling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identities of essential amino acids can also be inferred from analysis of identities with polypeptides that are related to the parent polypeptide.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochemistry 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

The total number of amino acid substitutions, deletions and/or insertions of the mature polypeptide of SEQ ID NO: 2 may not be more than 10, e.g., 1, 2, 3, 4, 5, 6, 7, 8 or 9.

A genomic DNA or cDNA library prepared from such other strains may, therefore, be screened for DNA that hybridizes with the probes described above and encodes a cyclomaltodextrin glucanotransferase. Genomic or other DNA from such other strains may be separated by agarose or polyacrylamide gel electrophoresis, or other separation techniques. DNA from the libraries or the separated DNA may be transferred to and immobilized on nitrocellulose or other suitable carrier material.

For purposes of the present invention, hybridization indicates that the nucleotide sequence hybridizes to a labeled nucleic acid probe corresponding to the polypeptide coding sequence of SEQ ID NO: 2.

In another aspect, the glycosyltransferase comprises a substitution, deletion, and/or insertion of one or more (or several) amino acids of the polypeptide of SEQ ID NO: 2, or a homologous sequence thereof. Preferably, amino acid changes are of a minor nature, that is conservative amino acid substitutions or insertions that do not significantly affect the folding and/or activity of the protein; small deletions, typically of one to about 30 amino acids; small amino- or carboxyl-terminal extensions, such as an amino-terminal methionine residue; a small linker peptide of up to about 20-25 residues; or a small extension that facilitates purification by changing net charge or another function, such as a poly-histidine tract, an antigenic epitope or a binding domain.

Baking Compositions

The present invention relates to baking compositions comprising a glycosyltransferase, a cyclomaltodextrin glucanotransferase, or a mixture of a glycosyltransferase and a cyclomaltodextrin glucanotransferase, and their preparation, e.g., compositions for improving the sliceability in a baked product.

The composition may further comprise one or more additional enzymes, in particular amylase, xylanase, glucanase, galactanase, mannanase, aminopeptidase, alpha-amylase, beta-amylase, anti-staling alpha-amylase, carboxypeptidase, catalase, chitinase, cutinase, deoxyribonuclease, esterase, alpha-galactosidase, beta-galactosidase, glucoamylase, alpha-glucosidase, beta-glucosidase, haloperoxidase, invertase, laccase, lipase, phospholipase, mannosidase, oxidase, pectinolytic enzymes, peptidoglutaminase, protease, peroxidase, phytase, and polyphenoloxidase.

The compositions may be prepared in accordance with methods known in the art and may have any physical appearance such as liquid, paste or solid. For instance, the composition may be formulated using methods known to the art of formulating enzymes and/or pharmaceutical products, e.g., into coated or uncoated granules or micro-granules. The glycosyltransferase, the cyclomaltodextrin glucanotransferase, or the mixture of a glycosyltransferase and a cyclomaltodextrin glucanotransferase, and any additional enzymes to be included in the composition may be stabilized in accordance with methods known in the art, e.g., by stabilizing the polypeptide in the composition by adding an antioxidant or reducing agent to limit oxidation of the polypeptide or it may be stabilized by adding polymers such as PVP, PVA, PEG, or other suitable polymers known to be beneficial to the stability of polypeptides in solid or liquid compositions.

When formulating the glycosyltransferase, the cyclomaltodextrin glucanotransferase, or the mixture of a glycosyltransferase and a cyclomaltodextrin glucanotransferase as a granulate or agglomerated powder, the particles preferably have a narrow particle size distribution with more than 95% (by weight) of the particles in the range from 25 to 500 μm. Granulates and agglomerated powders may be prepared by conventional methods, e.g., by spraying the glycosyltransferase, the cyclomaltodextrin glucanotransferase, or the mixture of a glycosyltransferase and a cyclomaltodextrin glucanotransferase onto a carrier in a fluid-bed granulator. The carrier may consist of particulate cores having a suitable particle size. The carrier may be soluble or insoluble, e.g., a salt (such as NaCl or sodium sulfate), a sugar (such as sucrose or lactose), a sugar alcohol (such as sorbitol), starch, rice, corn grits, or soy. The composition is preferably in the form of a dry powder or granulates, in particular a non-dusting granulate.

In one embodiment, the invention provides a granule comprising a glycosyltransferase, a cyclomaltodextrin glucanotransferase, or a mixture of a glycosyltransferase and a cyclomaltodextrin glucanotransferase.

In a particular embodiment, the composition is a dough composition or a dough improving additive or a premix comprising a glycosyltransferase, a cyclomaltodextrin glucanotransferase, or a mixture of a glycosyltransferase and a cyclomaltodextrin glucanotransferase.

The term “pre-mix” is defined herein to be understood in its conventional meaning, i.e., as a mix of baking agents, generally including flour, which may be used in industrial bread-baking plants, in retail bakeries, in baking mixes for home use, etc.

The pre-mix may be prepared by mixing the baking composition of the invention with a suitable carrier such as flour, starch, a sugar, a complex carbohydrate such as maltodextrin, or a salt. The pre-mix may contain other dough and/or bread additives, e.g., any of the additives, including enzymes, mentioned herein.

### The Additional Enzymes

Optionally, additional enzymes, such as amylase, xylanase, glucanase, galactanase, mannanase, aminopeptidase, alpha-amylase, beta-amylase, anti-staling alpha-amylase, carboxypeptidase, catalase, chitinase, cutinase, deoxyribonuclease, esterase, alpha-galactosidase, beta-galactosidase, glucoamylase, alpha-glucosidase, beta-glucosidase, haloperoxidase, invertase, laccase, lipase, phospholipase, mannosidase, oxidase, pectinolytic enzymes, peptidoglutaminase, protease, peroxidase, phytase, and polyphenoloxidase may be used together with the glycosyltransferase, the cyclomaltodextrin glucanotransferase, or the mixture of a glycosyltransferase and a cyclomaltodextrin glucanotransferase.

The additional enzyme may be of any origin, including mammalian and plant, and preferably of microbial (bacterial, yeast or fungal) origin.

The glucoamylase for use in the present invention include the A. niger G1 or G2 glucoamylase (Boel et al. (1984), EMBO J. 3 (5), p. 1097-1102), or the A. awamori glucoamylase disclosed in WO 84/02921, or the A. oryzae glucoamylase (Agric. Biol. Chem. (1991), 55 (4), p. 941-949).

The amylase may be fungal or bacterial, e.g., a maltogenic alpha-amylase from B. stearothermophilus or an alpha-amylase from Bacillus, e.g., B. licheniformis or B. amyloliquefaciens, a beta-amylase, e.g., from plant (e.g. soy bean) or from microbial sources (e.g. Bacillus), or a fungal alpha-amylase, e.g. from A. oryzae.

Suitable commercial anti-staling alpha-amylases include NOVAMYL™, in particular Novamyl 10 000 BG™, Novamyl 1500 MG™, Novamyl L™, and Novamyl Pro 80 BG™, Novamyl Pro 12 BG™, Novamyl Sweet™, Novamyl 3D™, OptiCake 50 BG™ and OptiCake Fresh BG™ (available from Novozymes A/S).

An anti-staling amylase for use in the invention may also be an amylase (glucan 1,4-alpha-maltotetrahydrolase (EC 3.2.1.60)) from Pseudomonas saccharophilia or variants thereof, e.g., Powerfresh G3™ or Powerfresh G4™ (available from Dupont/Danisco).

Suitable commercial fungal alpha-amylase compositions include, e.g., BAKEZYME P 300™ (available from DSM) and FUNGAMYL 2500 BG™, FUNGAMYL 4000 BG™, FUNGAMYL 800 L™, FUNGAMYL ULTRA BG™ and FUNGAMYL ULTRA SG™ (available from Novozymes NS).

The glucose oxidase may be a fungal glucose oxidase, in particular an Aspergillus niger glucose oxidase (such as GLUZYME™, available from Novozymes A/S, Denmark).

The protease may be from Bacillus, e.g., B. amyloliquefaciens.

The phospholipase may have phospholipase A1, A2, B, C, D or lysophospholipase activity; it may or may not have lipase activity. It may be of animal origin, e.g. from pancreas, snake venom or bee venom, or it may be of microbial origin, e.g. from filamentous fungi, yeast or bacteria, such as Aspergillus or Fusarium, e.g. A. niger, A. oryzae or F. oxysporum. A preferred lipase/phospholipase from Fusarium oxysporum is disclosed in WO 98/26057. Also, the variants described in WO 00/32758 may be used.

Suitable phospholipase compositions are LIPOPAN F™ and LIPOPAN XTRA™ (available from Novozymes A/S) or PANAMORE GOLDEN™ and PANAMORE SPRING™ (available from DSM).

The xylanase may be derived from a strain of Aspergillus, in particular A. aculeatus, A. niger, A. awamori, or A. tubigensis. The xylanase may be derived from a strain of Trichoderma, e.g., T. reesei, or from a strain of Humicola, e.g., H. insolens.

The xylanase may be derived from Bacillus, e.g., B. halodurans or B. subtilis.

Suitable commercially available xylanase preparations for use in the present invention include PANZEA BG™, PENTOPAN MONO BG™, PENTOPAN 500 BG™, PENTOPAN PLUS™ Panzea Dual™, and Fungamyl Super MA™ (available from Novozymes A/S), GRINDAMYL POWERBAKE™ (available from Danisco), and BAKEZYME BXP 5000™ and BAKEZYME BXP 5001™ (available from DSM).

### Dough

In one aspect, the invention discloses a method for preparing dough or a baked product prepared from the dough which method comprises incorporating into the dough a glycosyltransferase, a cyclomaltodextrin glucanotransferase, or a mixture of a glycosyltransferase and a cyclomaltodextrin glucanotransferase.

In another aspect, the invention provides dough comprising flour, water, and an effective amount of a baking composition or a premix according to the invention.

The present invention also relates to methods for preparing a dough or a baked product comprising incorporating into the dough an effective amount of a baking composition of the present invention which improves one or more properties of the dough or the baked product obtained from the dough relative to a dough or a baked product in which a glycosyltransferase, a cyclomaltodextrin glucanotransferase, or a mixture of a glycosyltransferase and a cyclomaltodextrin glucanotransferase is not incorporated.

The phrase “incorporating into the dough” is defined herein as adding the baking composition according to the invention to the dough, to any ingredient from which the dough is to be made, and/or to any mixture of dough ingredients from which the dough is to be made. In other words, the baking composition of the invention may be added in any step of the dough preparation and may be added in one, two or more steps. The composition is added to the other dough ingredients that is kneaded and baked to make the baked product, using methods well known in the art.

The term “effective amount” is defined herein as an amount of baking composition according to the invention that is sufficient for providing a measurable effect on at least one property of interest of the dough and/or baked product.

The term “dough” is defined herein as a mixture of flour and other ingredients firm enough to knead or roll.

The dough of the invention may comprise flour derived from any cereal grain, including wheat, barley, rye, oat, corn, sorghum, rice, and millet, and any mixtures thereof. The dough may be with or without fibers from cereal grains.

The dough may also comprise other conventional dough ingredients, e.g., proteins, such as milk powder, gluten, and soy; eggs (either whole eggs, egg yolks or egg whites); an oxidant such as ascorbic acid, potassium bromate, potassium iodate, azodicarbonamide (ADA) or ammonium persulfate; an amino acid such as L-cysteine; a sugar; a salt such as sodium chloride, calcium acetate, sodium sulfate or calcium sulfate; an oil; shortening; fat; and calcium propionate.

The dough may comprise one or more emulsifiers selected from the group consisting of diacetyl tartaric acid esters of monoglycerides (DATEM), sodium stearoyl lactylate (SSL), calcium stearoyl lactylate (CSL), ethoxylated mono- and diglycerides (EMG), polysorbates (PS), succinylated monoglycerides (SMG), monoacylglyceroles (MAG), diacylglyceroles (DAG), and mixtures thereof. The amount of emulsifier in the dough may typically be between 0.01% (w/w) and 0.5% (w/w). Preferably, the amount of emulsifier in the dough is between 0.05% and 0.2%, such as around 0.1%.

The dough of the invention may be fresh, frozen or par-baked (pre-baked).

The dough of the invention is normally leavened dough or dough to be subjected to leavening. The dough may be leavened in various ways, such as by adding chemical leavening agents, e.g., sodium bicarbonate or by adding a leaven (fermenting dough), but it is preferred to leaven the dough by adding a suitable yeast culture, such as a culture of Saccharomyces cerevisiae (baker's yeast), e.g., a commercially available strain of S. cerevisiae.

The amount of glycosyltransferase may be 0.01-100 mg enzyme protein per kg flour in the dough, in particular 0.01-50 mg enzyme protein per kg flour, in particular 0.01-10 mg enzyme protein per kg flour, in particular 0.01-5 mg enzyme protein per kg flour, in particular 0.01-1 mg enzyme protein per kg flour.

The amount of cyclomaltodextrin glucanotransferase may be 0.01-100 mg enzyme protein per kg flour in the dough, in particular 0.01-50 mg enzyme protein per kg flour, in particular 0.01-10 mg enzyme protein per kg flour, in particular 0.01-5 mg enzyme protein per kg flour, in particular 0.01-1 mg enzyme protein per kg flour.

### Baked Product

The process of the invention may be used for any kind of baked product prepared from dough, either of a white, light or dark type. As used herein, “baked product” means any kind of baked product (in particular white, whole-meal or rye bread), including bread types such as pan bread, sandwich bread, toast bread, lidded toast bread, open bread, pan bread with and without lid, and any variety thereof; especially lidded toast bread.

### Slicing at High Temperatures

Core temperature: The core temperature of the baked product may be measured using a precision core thermometer (TFX 410 handheld thermometer, Ebro, Germany) fitted with a PT 1000 pointed probe by inserting the probe into the bread core immediately after retrieving bread from oven.

Bread was let to cool off on a perforated baking sheet kept at room temperature of e.g. (24±0.5° C.) and held up in a rack by its edges so that hot air could move away from the bread. Bread was sliced when desired core bread temperature (±0.5° C.) or, e.g., (±1.0° C.) was reached.

According to the present invention, the baked product may be sliced at a core temperature of the baked product of 30-55° C.; e.g., at a core temperature of the baked product of 31-55° C.; e.g., at a core temperature of the baked product of 32-55° C.; e.g.; at a core temperature of the baked product of 33-55° C.; e.g., at a core temperature of the baked product of 34-55° C.; e.g., at a core temperature of the baked product of 35-55° C.; e.g., e.g., at a core temperature of the baked product of 36-55° C.; e.g., at a core temperature of the baked product of 37-55° C.; e.g., at a core temperature of the baked product of 38-55° C.; e.g., at a core temperature of the baked product of 39-55° C.; e.g., at a core temperature of the baked product of 40-55° C.; e.g., at a core temperature of the baked product of 41-55° C.; e.g., at a core temperature of the baked product of 42-55° C.; e.g., at a core temperature of the baked product of 43-55° C.; e.g., at a core temperature of the baked product of 44-55° C.; e.g., at a core temperature of the baked product of 45-55° C.; e.g.; at a core temperature of the baked product of 35-38° C.; e.g., at a core temperature of the baked product of 38-40° C.; e.g., at a core temperature of the baked product of 40-42° C.; e.g., at a core temperature of the baked product of 42-44° C.; e.g., at a core temperature of the baked product of 44-46° C.; e.g., at a core temperature of the baked product of 48-50° C.; e.g., at a core temperature of the baked product of 50-55° C.; e.g., at a core temperature of the baked product of 30-50° C.; e.g., at a core temperature of the baked product of 35-50° C.; e.g., at a core temperature of the baked product of 40-50° C.

The present invention is further described by the following examples which should not be construed as limiting the scope of the invention.

### Example 1

### Preparation of Lidded Toast Bread

Lidded toast bread (700 g) was made from dough prepared according to a standard European straight dough procedure with 580 g water, 40 g yeast, 20 g salt, 20 g sugar, 60 ppm ascorbic acid, and 4 g calcium propionate (as preservative) per kg of flour.

Dough was scaled to 700 g, proofed (60 min, 36-38° C., 80-90% relative humidity) and baked for 30 min at 225° C. in lidded pans.

The breads were baked in single (non-attached) baking pans in a rotary oven.

The breads were sliced at a core temperature of 48-50° C., using an automatic bread slicer, most preferably the Roto-Shop de Luxe slicer (Rego Hertlitzius Gmbh, Nordrhein-Westfalen, Germany). The slices had a thickness of approximately 12.5 mm.

All breads contained a common background of ascorbic acid (60 mg per kg flour), and enzymes to ensure that the bread had quality properties comparable to those found in commercial breads. The common background of enzymes was composed of fungal alpha-amylase (FUNGAMYL 2500 BG) at a dosage of 6 mg per kg flour, and xylanase (PANZEA BG) at a dosage of 30 mg per kg flour.

### Example 2

### Impact of Glycosyltransferase (SEQ ID NO: 1) on Bread Sliceability

Lidded toast breads (700 g) were made according to Example 1 (control).

Lidded toast breads (700 g) were made according to Example 1 (control) except that additionally, 0.5% (w/w) Puratos' Soft′R Intense Sliceability™ was added (a commercial product from Puratos).

Lidded toast breads (700 g) were made according to Example 1 (control) except that additionally, glycosyltransferase (SEQ ID NO:1) was added in an amount of 0.16 mg enzyme protein per kg flour.

The breads baked with glycosyltransferase (SEQ ID NO:1) showed slicing properties that were much better than the control, and also better than the breads baked with the commercial improver Puratos' Soft′R Intense Sliceability.

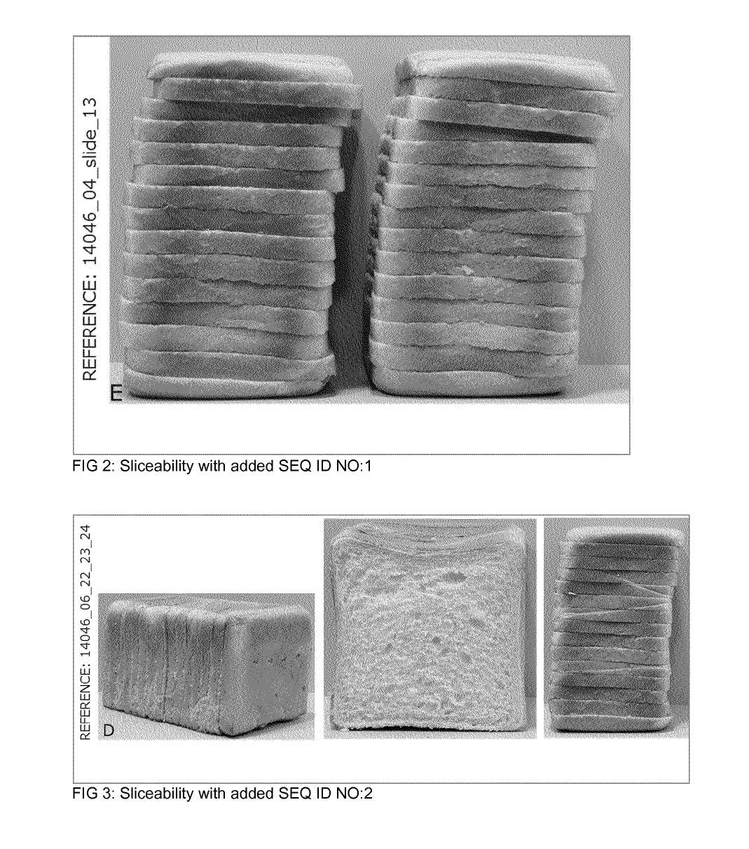

FIG. 2 shows the bread baked with SEQ ID:1.

### Example 3

### Impact of Cyclomaltodextrin Glucanotransferase (SEQ ID NO: 2) on Bread Sliceability

Lidded toast breads (700 g) were made according to Example 1 except that additionally, cyclomaltodextrin glucanotransferase (SEQ ID NO:2) was added in an amount of 0.75 mg enzyme protein per kg flour.

The breads baked with cyclomaltodextrin glucanotransferase (SEQ ID NO: 2) showed improved sliceability as judged by reduced occurrence of loaf deformation, single or multiple slice deformation, and peeling of the crumb surface, no sticking of contiguous slices, reduced peeling off of crumb surface, and reduced overall deterioration of crumb grain texture.

FIG. 3 shows the bread baked with SEQ ID NO:2.

### Example 4

### Impact of a Mixture of Glycosyltransferase (SEQ ID NO: 1) and Cyclomaltodextrin Glucanotransferase (SEQ ID NO: 2) on Bread Sliceability

Lidded toast breads (700 g) were made according to Example 1 (control).

Lidded toast bread (700 g) were made according to Example 1 except that additionally, 0.5% (w/w) Puratos' Soft′R Intense Sliceability™ was added (a commercial product from Puratos). Lidded toast breads (700 g) were made according to Example 1 except that additionally, glycosyltransferase (SEQ ID NO:1) was added in an amount of 0.08 mg enzyme protein/kg flour and cyclomaltodextrin glucanotransferase (SEQ ID NO: 2) was added in an amount of 0.15 mg enzyme protein/kg flour.

FIG. 1 shows the results.

The arrows show slicing defects such as the permanent deformation of single or multiple slices, peeling off of crumb surface, and undue deterioration of crumb grain texture.

FIG. 1 shows how slicing defects in loaf bread were improved by the use of glycosyltransferase (SEQ ID NO:1) and cyclomaltodextrin glucanotransferase (SEQ ID NO: 2) in combination, as judged by occurrence of loaf deformation, single or multiple slice deformation and peeling of the crumb surface, reduced overall deterioration of crumb grain texture.

### Example 5

### Impact of Glycosyltransferase (SEQ ID NO: 1), and a Mixture of Glycosyltransferase (SEQ ID NO: 1) and Cyclomaltodextrin Glucanotransferase (SEQ ID NO: 2) on Sliceability of Lidded Toast Bread

White pans breads were made in the following way (the flour used was Meneba Kolibri):

TABLE 1
White pan bread recipe

| Recipe: | % | g |
|---|---|---|
| Water | 59 | 1180 |
| Flour | 100 | 2000 |
| Yeast | 3.5 | 70 |
| Salt | 2 | 40 |
| Sugar | 2 | 40 |
| Calcium propionate | 0.4 | 8.0 |

TABLE 2
Bread making process

| Process: | Time (min) |
|---|---|
| Spiral mixer slow | 0:02 |
| Spiral mixer fast | 0:10 |
| Dough evaluation | 0:05 |
| Scale 4 × 700 g rounding | 0:05 |
| Table resting at 24° C. (covered) | 0:10 |
| Moulding: 5/4/20/15 | 0:02 |
| Panning with 4piece method | 0:08 |
| Fermentation: 38° C.; 90% RH | 1:00 |
| Baking rotary oven: 225° C./220° C. | 0:30 |

All breads contained a common background of ascorbic acid (60 mg per kg flour), and enzymes to ensure that the bread had quality properties comparable to those found in commercial breads. The common background of enzymes was composed of fungal alpha-amylase (FUNGAMYL 2500 BG) at a dosage of 6 mg per kg flour, and xylanase (PANZEA BG) at a dosage of 30 mg per kg flour.

Additionally, either glycosyltransferase (SEQ ID NO:1) at a concentration of 0.10 mg enzyme protein per kg flour, or a mixture of glycosyltransferase (SEQ ID NO:1) at a concentration of 0.075 mg enzyme protein per kg flour and cyclomaltodextrin glucanotransferase (SEQ ID NO: 2) at a concentration of 0.12 mg enzyme protein per kg flour were added.

The bread loaves were sliced as described in Example 1. Bread loaves were sliced at a temperature of 44±1° C. Slice thickness was 12.5 mm.

The number of intact and damaged slices per loaf of bread was manually counted after the slicing step. The experiment was repeated four times (true replicates) and each replication value was the averaged count of four loaves of bread.

As shown in Table 3, the average number of intact slices in a loaf of bread increased and the number of damaged slices decreased due to addition of glycosyltransferase (SEQ ID NO:1), or the addition of glycosyltransferase (SEQ ID NO:1) and cyclomaltodextrin glucanotransferase (SEQ ID NO: 2). Table 4 shows the same effects as shown in Table 3 but expressed as a percentage of the total number of slices per loaf.

TABLE 3
Means of sliceability characteristics (# intact and # damaged
slices per loaf of 15 slices) of bread as a function of enzyme treatment

| Enzyme treatment | # Intact slices | #Damaged slices |
|---|---|---|
| No enzyme | 10.9 | 4.2 |
| glycosyltransferase (SEQ ID | 12.6 | 2.4 |
| NO: 1) in an amount of 0.10 mg | | |
| enzyme protein per kg flour | | |
| glycosyltransferase (SEQ ID | 13.7 | 1.3 |
| NO: 1) was added in an amount | | |
| of 0.075 mg enzyme protein/kg | | |
| flour and cyclomaltodextrin | | |
| glucanotransferase (SEQ ID | | |
| NO: 2) was added in an | | |
| amount of 0.12 mg enzyme | | |
| protein/kg flour | | |

TABLE 4
Means of sliceability characteristics (percent
intact and percent damaged slices of total slices in a
loaf) of bread as a function of enzyme treatment

| Enzyme treatment | # Intact slices | #Damaged slices |
|---|---|---|
| No enzyme | 72.9% | 27.9% |
| glycosyltransferase (SEQ ID | 84.2% | 15.8% |
| NO: 1) was added in an amount | | |
| of 0.10 mg enzyme protein per | | |
| kg flour | | |
| glycosyltransferase (SEQ ID | 91.3% | 8.8% |
| NO: 1) was added in an amount | | |
| of 0.075 mg enzyme protein/kg | | |
| flour and cyclomaltodextrin | | |
| glucanotransferase (SEQ ID | | |
| NO: 2) was added in an | | |
| amount of 0.12 mg enzyme | | |
| protein/kg flour | | |

### CONCLUSION

Table 3 and Table 4 clearly show that it is possible to increase the number of intact slices in a loaf by using the enzyme(s) of the present invention.

1. A method of improving sliceability of a baked product prepared from a dough comprising:
incorporating into the dough a glycosyltransferase (EC 2.4.1.18) and/or a cyclomaltodextrin glucanotransferase;
baking the dough into a baked product; and
slicing the baked product during the cooling period when the baked product has a core temperature of 30-55° C.

2. The method according to claim 1, wherein the glycosyltransferase has at least 80% sequence identity to the polypeptide of SEQ ID NO: 1.

3. The method according to claim 1, wherein the cyclomaltodextrin glucanotransferase has at least 80% sequence identity to the polypeptide of SEQ ID NO: 2.

4. The method according to claim 1, wherein a glycosyltransferase and a cyclomaltodextrin glucanotransferase are incorporated into the dough.

5. The method according to claim 1, which further comprises adding to the dough an enzyme selected from the group consisting of amylase, xylanase, glucanase, galactanase, mannanase, aminopeptidase, alpha-amylase, beta-amylase, anti-staling alpha-amylase, carboxypeptidase, catalase, chitinase, cutinase, deoxyribonuclease, esterase, alpha-galactosidase, beta-galactosidase, glucoamylase, alpha-glucosidase, beta-glucosidase, haloperoxidase, invertase, laccase, lipase, phospholipase, mannosidase, oxidase, pectinolytic enzymes, peptidoglutaminase, protease, peroxidase, phytase, and polyphenoloxidase.

6. The method according to claim 1, wherein the glycosyltransferase and/or the cyclomaltodextrin glucanotransferase is applied in an amount of 0.01-100 mg enzyme protein per kg flour.

7. The method according to claim 1, wherein the baked product is sliced at a core temperature of the baked product of 38-55° C.

8. The method according to claim 1, wherein the sliceability of the baked product is improved compared to a baked product prepared from dough wherein no glycosyltransferase and/or a cyclomaltodextrin glucanotransferase is added to the dough.

9. The method according to claim 1, wherein the baked product is a bread; preferably a toast bread.

10. The method according to claim 1, wherein the crumb structure of the baked product is improved compared to a baked product prepared from dough wherein no glycosyltransferase and/or a cyclomaltodextrin glucanotransferase is added to the dough.

11. A baking composition comprising a glycosyltransferase (EC 2.4.1.18) and/or a cyclomaltodextrin glucanotransferase for use in improving sliceability of a baked product, wherein the baked product has a core temperature of 30-55° C.

12. The baking composition according to claim 11, which further comprises an enzyme selected from the group consisting of amylase, xylanase, glucanase, galactanase, mannanase, aminopeptidase, alpha-amylase, beta-amylase, anti-staling alpha-amylase, carboxypeptidase, catalase, chitinase, cutinase, deoxyribonuclease, esterase, alpha-galactosidase, beta-galactosidase, glucoamylase, alpha-glucosidase, beta-glucosidase, haloperoxidase, invertase, laccase, mannosidase, oxidase, pectinolytic enzymes, peptidoglutaminase, protease, peroxidase, phytase, and polyphenoloxidase.

13. A pre-mix comprising a baking composition according to claim 11, comprising flour, and one or more dough or bread additives for use in improving sliceability of a baked product, wherein the baked product has a core temperature of 30-55° C.

14. (canceled)


SEQUENCE LISTING (2 sequences)

SEQ ID NO: 1 - protein, 621 aa, Rhodothermus obamensis
MSWLTEEDIRRWESGTFYDSYRKLGAHPDDEGTWFCVWAPHADGVSVLGAFNDWNPEANPLERYGGGLWAGYVPGARPGHTYKYRIRHGFYQADKTDPYAFAMEPPTGSPIEGLASIITRLDYTWHDDEWMRRRKGPASLYEPVSIYEVHLGSWRHKRPGESFSYREIAEPLADYVQEMGFTHVELLPVMEHPYYGSWGYQVVGYYAPTFRYGSPQDLMYLIDYLHQRGIGVILDWVPSHFAADPQGLVFFDGTTLFEYDDPKMRYHPDWGTYVFDYNKPGVRNFLISNALFWLEKYHVDGLRVDAVASMLYRDYSRKEWTPNIFGGRENLEAIDFIKKFNETVYLHFPEAMTIAEESTAWPGVSAPTYNNGLGFLYKWNMGWMHDTLDYIQRDPIYRKYHHDELTFSLWYAFSEHYVLPLSHDEVVHGKGSLWGKMPGDDWQKAANLRLLFGHMWGHPGKKLLFMGGEFGQHHEWNHDTQLEWHLLDQPYHRGIQLWVCDLNHLYRTNPALWHDGPEGFEWIDFSDRDQSVICYLRKNAGRMLLFVLNFTPVPREHYRVGVPIGGPWHEVLNSDAVAYGGSGMGNFGRVEAVPESWHGRPFHLELTLPPLAALILEPEHG

SEQ ID NO: 2 - protein, 683 aa, Thermoanaerobacter sp.
APDTSVSNVVNYSTDVIYQIVTDRFLDGNPSNNPTGDLYDPTHTSLKKYFGGDWQGIINKINDGYLTGMGITAIWISQPVENIYAVLPDSTFGGSTSYHGYWARDFKKTNPFFGSFTDFQNLIATAHAHNIKVIIDFAPNHTSPASETDPTYGENGRLYDNGVLLGGYTNDTNGYFHHYGGTNFSSYEDGIYRNLFDLADLDQQNSTIDSYLKAAIKLWLDMGIDGIRMDAVKHMAFGWQKNFMDSILSYRPVFTFGEWYLGTNEVDPNNTYFANESGMSLLDFRFAQKVRQVFRDNTDTMYGLDSMIQSTAADYNFINDMVTFIDNHDMDRFYTGGSTRPVEQALAFTLTSRGVPAIYYGTEQYMTGNGDPYNRAMMTSFDTTTTAYNVIKKLAPLRKSNPAIAYGTQKQRWINNDVYIYERQFGNNVALVAINRNLSTSYYITGLYTALPAGTYSDMLGGLLNGSSITVSSNGSVTPFTLAPGEVAVWQYVSTTNPPLIGHVGPTMTKAGQTITIDGRGFGTTAGQVLFGTTPATIVSWEDTEVKVKVPALTPGKYNITLKTASGVTSNSYNNINVLTGNQVCVRFVVNNATTVWGENVYLTGNVAELGNWDTSKAIGPMFNQVVYQYPTWYYDVSVPAGTTIEFKFIKKNGSTVTWEGGYNHVYTTPTSGTATVIVDWQP